(19) United States
(12) Patent Application Publication
(10) Pub. No.: US 2014/0329054 A1
(43) Pub. Date: Nov. 6, 2014

(54) AQUEOUS INK FORMULATION CONTAINING METAL-BASED NANOPARTICLES FOR USAGE IN MICRO CONTACT PRINTING

(71) Applicant: BAYER INTELLECTUAL PROPERTY GMBH, Monheim (DE)

(72) Inventors: Deivaraj Theivanayagam Chairman, Singapore (SG); Frank Sicking, Overath (DE); Venkataramanan Balasubramanian, Singapore (SG); Daniel Rudhardt, Koln (DE)

(73) Assignee: CLARIANT INTERNATIONAL AG, Muttenz (CH)

(21) Appl. No.: 14/347,428

(22) PCT Filed: Sep. 25, 2012
(86) PCT No.: PCT/EP2012/068835

§ 371 Date: Mar. 26, 2014

(30) Foreign Application Priority Data
Sep. 30, 2011 (SG) 2011 07156-0

(51) Int. Cl. C09D 11/02; B41M 1/26; B41M 7/00; C09D 11/00

(52) U.S. Cl. CPC C09D 11/03; C09D 11/52; B41M 1/26; B41M 7/009
USPC 428/156; 252/512; 252/514; 106/31.13; 106/18.35; 101/487

(57) ABSTRACT

The present invention relates to an aqueous formulation particularly for generating electrically conductive and/or reflective structures by microcontact printing, characterized in that the formulation contains at least a) ≧15 to ≦55 parts by weight water, b) ≧10 to ≦50 parts by weight alcohol, c) ≧15 to ≦45 parts by weight metal-based nanoparticles, d) 0.5 to ≦10 parts by weight non-fluorinated surfactant, and e) ≧0.5 to ≦10 parts by weight fluorinated surfactant, wherein the above defined constituents a) to e) summarize to a concentration of ≦100 parts by weight in the formulation. The wetting behavior especially of hydrophobic materials may significantly be improved. The present invention further relates to a method of generating structures, particularly being electrically conductive and/or reflective, on a substrate by microcontact printing and a substrate comprising such a structure.

The present invention relates to an aqueous formulation containing metal-based nanoparticles, in particular silver, especially for generating electrically conductive and/or optically reflective structures particularly by microcontact printing, in particular on flexible and/or transparent substrates using a stamp made of poly-(dimethylsiloxane). The present invention further relates to a method of generating structures, particularly being electrically conductive and/or optically reflective, on a substrate by microcontact printing using the above defined formulation. The present invention further relates to a substrate comprising such a structure.

Microcontact Printing (μCP) is touted to be a simple and a versatile printing process, that employs micro-patterned stamps, for example made of poly-(dimethylsiloxane) (PDMS) in order to print micro scale features onto various substrates. The substrates may include those being curved and having a large area. Microcontact printing can be used to print, inter alia, self assembled monolayers (SAM's), polymers, dendrimers, catalysts or biomolecules such as proteins, liposomes, etc. on substrates of choice. However, there are very few reports on printing nanoparticles using microcontact printing. For instance, printing of titanium dioxide (TiO₂) nanoparticles or quantum dots using microcontact printing have been reported.

By using stamps made of poly-(dimethylsiloxane), furthermore, this material being a non-polar elastomer with a hydrophobic surface presents some challenges due to its low surface energy, thus resulting in poor wetting of polar ink systems, such as aqueous based ink systems. Therefore, methods are known to modify the surface of the poly-(dimethylsiloxane) stamps in order to increase the surface energy and furthermore to improve the wetting behavior of polar ink systems. These modifying procedures are typically multistep processes involving plasma treatment and surface grafting of polar moieties on the poly-(dimethylsiloxane) surface. However, the surface after the modification route often presents limited success as the wettability appears to be getting poor with repeated usage and/or storage.

An alternative would be to microcontact print metallic colloids directly onto substrates of choice. However, there appears to be not much information on printing metallic nanoparticles using microcontact printing. For instance, microcontact printing of Pd/Sn or Pd nanoparticles on poly-(dimethylsiloxane) stamps was reported as seeds for a further electroless deposition of NiB or copper. It has to be noted that the Pd/Sn nanoparticles are only used as seeds layers and this could as well be a random deposition of nanoparticles and not really dense structures. It must also be highlighted that these seed nanoparticles are often dispersed in organic solvents like toluene or hexane.

Most of the known printing of metallic conducting pattern was performed by passivating gold surfaces by a self assembled monolayer of a suitable thiol followed by electrodeposition/electroless deposition of a metallic species on the unpassivated sections of the substrates and finally a wet etching to remove the uncoated areas of the gold surface. It is obvious that this type of patterning is process intensive and cumbersome.

Known from US 2009/0191355 A1 is a method of forming a layer of particulate on a substrate, and in particular, a method of forming a thin layer of nanometer sized particulate on a substrate for use in microfabrication of components and devices. The method according to this document generally comprises the steps of providing an elastomeric stamp having a relief structure; applying a composition comprising particulate and a dispersing agent to the relief structure; selectively transferring the composition from the relief structure to the substrate to form the pattern; treating the composition with charged gas to remove the dispersing agent; and induction heating to form functional connection of the particulate. The ink used for performing this method may contain conductive materials such as silver and in particular silver nanoparticles, a binder, and methanol as solvent.

Document WO 2009/052120 A1 describes a method of microfabrication and nanofabrication of electrical and mechanical structures at the micron and submicron scale, for example by microcontact printing. This method uses a formulation comprising a plurality of metallic nanoparticles, such as silver nanoparticles, suspended in a carrier, wherein the carrier comprises water and at least one organic solvent miscible with water. The organic solvent being miscible with water may be an alcohol, such as terpene alcohol or a polyol, such as glycol or glycerol, or a long chain alcohol, such as octanol or decanol. Furthermore, the formulation known from this document may comprise additives such as surfactants or dispersants.

However, with respect to the above defined prior art, the swelling and wetting behavior has further potential to be improved especially in absence of surface modification of the poly-(dimethylsiloxane) stamp. In detail, a plasma or UV/ozone surface treatment for wetting of the stamp such as the stamp made of poly-(dimethylsiloxane) should be avoided.

Consequently, there is the need for further ink formulations improving the printability and particularly the wetting behavior especially of a hydrophobic material such as a poly-(dimethylsiloxane) stamp without pretreating the stamp. It is thus the object of the present invention to provide an aqueous formulation being usable as ink for microcontact printing which has an improved wetting behavior of a hydrophobic material such as of a stamp made of poly-(dimethylsiloxane).

The present invention relates to an aqueous formulation particularly for generating electrically conductive and/or reflective structures by microcontact printing, characterized in that the formulation contains at least
a) ≧15 to ≦55 parts by weight water,
b) ≧10 to ≦50 parts by weight alcohol,
c) ≧15 to ≦45 parts by weight metal-based nanoparticles,
d) ≧0.5 to ≦10 parts by weight non-fluorinated surfactant, and
e) ≧0.5 to ≦10 parts by weight fluorinated surfactant,
   wherein the above defined constituents a) to e) summarize to a concentration of ≦100 parts by weight in the formulation.

The term “metal-based” nanoparticles in the sense of the present invention shall particularly mean any nanoparticles which comprise a metal as such or a compound being at least partly formed from a metal compound, such as an alloy, metal oxides or the like. As an example for metal oxides, titanium oxide (TiO₂) or indium tin oxide (ITO) may be referred to in an exemplary manner only. Consequently, at any passage metal-based nanoparticles are cited, these particles may be metals, alloys, or metal compounds such as metal oxides. Apart from that, the term “nanoparticles” in the sense of the present invention may exemplarily mean particles having a maximum diameter in a range of ≦250 nm, for example lying in the range of ≧1 nm to ≦250 nm

The term “structure” in the sense of the present invention shall particularly mean any kind of material being applied to the surface of a substrate. In detail, the term structure comprises a layer being applied to a whole or an expanded region of a surface area, such as a large region coating, or a defined pattern being applied just to defined regions onto the surface of the substrate.

The term “microcontact printing” according to the present invention shall particularly mean a process being generally known in the art. This process comprises the steps of applying a formulation, or an ink, respectively, onto a surface or at least onto a part of the latter of a stamp, which may be structured or not. The ink being applied to the stamp is in turn transferred to a suited substrate in order to apply a structure onto the latter.

A formulation according to the present invention overcomes the problems of wetting without having to subject a hydrophobic surface, such as a poly-(dimethylsiloxane) surface, to a lengthy and cumbersome surface modification procedure. Apart from that, the formulation according to the invention does not swell stamps made of a hydrophobic material, such as poly-(dimethylsiloxane).

Without being bound to the theory it is believed that the positive effects and advantages being provided by an aqueous formulation particularly for generating electrically conductive and/or reflective coatings according to the invention are obtained by synergistic effects of the respective components. Particularly, it is believed that the advantages are obtained by the components being present in the formulation according to the invention in a respective concentration range.

Next to the components defined above, the ink formulation according to the invention may comprise further constituents without leaving the scope of the invention as such. For example, the formulation may comprise at least one additive in order to improve one or more of the properties of the formulation or to adapt them to the special use. The further one or more additives being potentially part of the ink formulation according to the invention may be selected from the group comprising or consisting of surfactants, pigments, defoamers, light protecting agents, lighteners, wighteners, corrosion inhibitors, antioxidants, algicides, plasticizers, softeners, and/or thickeners, the list not being strictly final.

The components being present in the ink formulation according to the present invention are particularly chosen in view of the wetting behavior on a stamp with regard to microcontact printing in a method of generating electrically conductive and/or reflective structures. Consequently, the constituents being present in the ink formulation according to the present invention are particularly chosen in view of the wetting behavior on hydrophobic materials, such as poly-(dimethylsiloxane).

Within the in formulation according to the invention, the metal-based nanoparticles essentially serve as main ingredient of the particularly electrically conductive and/or reflective structure to be generated on the substrate of choice. They may be present in the formulation according to the invention in a concentration in the range of ≧15 to ≦45 parts by weight. It is clear for one skilled in the art that either the same kind of nanoparticles may be present in the formulation according to the invention, or different kinds of nanoparticles may be present in the formulation according to the invention without leaving the invention as such.

The water being present may serve as solvent for dispersing the metal-based nanoparticles. It may be present in a concentration in the range of ≧15 to ≦55 parts by weight.

Within the ink formulation according to the present invention, the alcohol may be present in a concentration in the range of ≧10 to ≦50 parts by weight and may serve as co-solvent. Additionally, it may take the role as wetting agent.

With respect to the non-fluorinated surfactant, the latter may especially serve as agent for reducing the surface tension of the ink, so that the wetting behavior of the stamp may be further improved. It may be present in a concentration in the range of ≧0.5 to ≦10 parts by weight.

With respect to the fluorinated surfactant, the latter may especially serve as leveling agent and/or agent for reducing the surface tension of the ink, providing positive aspects with respect to the wetting behavior. It may be present in a concentration in the range of ≧0.5 to ≦10 parts by weight in the formulation.

The ink formulation according to the invention may provide superb wetting behavior, which is especially advantageous with respect to microcontact printing. In detail, by having a good wetting behavior, the stamp, especially being formed of a hydrophobic material, such as poly-(dimethylsiloxane), may be wettened and thus provided with the ink formulation in a defined manner. Consequently, especially in case the stamp is structured in order to generate a defined structure on a substrate, a good wetting behavior is advantageous in order to generate the desired structure by transferring the ink to the substrate. A structured stamp may thereby particularly mean a stamp having at least one surface being provided with a structure. The structure, in order to be suitable for microcontact printing, may particularly have protruding and recessed portions forming the required structure. The structure as such may be adjusted to the desired application. It may thus comprise defined areas, lines or spots, for example. By addressing the problems known in the art with respect to wetting, it may be assured that the desired geometry and form of the structure to be applied, as defined by the stamp or the stamp structure, may accurately be transferred to a substrate of choice.

It is thereby not necessary to modify the surface of the stamp by chemically or physically processing the latter. The wettability may instead be improved by the ink formulation as such. Consequently, a printing process may be performed without a further step resulting in a highly efficient and cost saving process.

The dimensions and/or structures are furthermore just dependent from the stamp, or its structure, respectively, being used and the pressure applied to the latter. Consequently, by using an ink formulation according to the present invention, it is possible to print conducting and/or reflecting metal structures, for example, in various dimensions.

It is also possible to print semi-transparent grid structures, for example with sheet resistances less than 5 Ω/sq., especially if appropriate sintering conditions are chosen after transferring the formulation to the substrate. With respect to the electrically conductive structures being formed on the substrate of choice, such as conducting paths, or large area coatings, they may preferably be temperature resistant, for example at least for a short period of time up to 4000° C., as well as mechanically flexible. The ink formulation according to the invention may furthermore be suitable for generating structures, or lines, respectively, having a width of 100 μm or less (up to 20 μm or even lower). This may especially be advantageous with respect to small dimensioned substrates. Apart from that, the applicability of the ink formulation according to the present invention is especially broad.

Furthermore, the ink formulation according to the present invention is especially cost-saving to prepare and to use and, additionally, may provide a superb shelf life. Furthermore, due to the fact that the desired structures may appropriately be generated, the degree of substrate being falsely coated and thus not being usable for the desired application may be reduced up to a minimum Consequently, the ink formulation according to the present invention may provide a high efficiency at its use.

Besides, the ink formulation according to the present invention prevents the stamp used for printing from swelling and/or shrinking. In detail, shrinking is a process due to which the stamp changes its dimensions leading to the dimensions of the structure being present on the printing surface of the stamp as well being changed. Consequently, the printed structure will not have the dimensions desired in case the stamp shrinks. Additionally, most organic solvents lead to a swelling process of a stamp particularly formed from poly-(dimethylsiloxane), as well having negative effects to the stamp and thus to the printing results. These above named disadvantaged may be prevented by using an aqueous based formulation according to the present invention.

Even if the ink formulation according to the present invention is particularly suitable for microcontact printing and in more detail for microcontact printing using a hydrophobic stamp, it is especially suitable for any kind of printing technology employing a hydrophobic material to transfer a structure, or a pattern, respectively, to a substrate of choice.

It is the benefit of the present inventors to have found out that the object of the present invention is surprisingly solved by a suitable choice of an ink formulation having defined constituents particularly in defined concentration ranges. The effect according to the invention is provided, without being bound to a specific theory, particularly by synergistic effects of solvents, co-solvents and surfactants and potentially further additives especially in defined concentration ratios.

According to an embodiment, the metal-based nanoparticles comprise silver nanoparticles. Preferably, all metal nanoparticles are silver nanoparticles. The silver nanoparticles may preferably be used, or introduced into the formulation, respectively, in the form of a silver nanoparticle sol (Ag sol). The silver nanoparticle sol may be treated and thus particularly purified and concentrated by using membrane filtration comprising a filter element with a level of filtering of 100.00 dalton at most, for example. The silver nanoparticle sol preferably comprises a dispersing agent, which may be formed from a block-copolyether comprising styrene blocks, with 62 parts by weight C₂-polyether, 23 parts by weight C₃-polyether, and 15 parts by weight polystyrene, with respect to the dried dispersing agent, with a relation of the length of the blocks C₂ polyether to C₃ polyether of 7:2 units (for example Disperbyk 190, purchasable by BYK-Chemie, Wesel). By way of the dispersing agent, which may serve as capping agent, the silver nanoparticles are stabilized appropriately. Consequently, agglomeration of the silver nanoparticles may be prevented.

According to a further embodiment the alcohol may be ethanol, isopropanol, methanol or a mixture comprising at least one of the afore-mentioned compounds. Particularly by using methanol, the wettability properties of the ink according to the invention were found to be especially improved. Furthermore, methanol has a preferred evaporation rate providing a very short drying time of the silicone stamp provided with the ink formulation, or the substrate provided with the structure. Apart from that, methanol is cost-saving to use and is furthermore non problematic with respect to its handling conditions.

According to a further embodiment the metal-based nanoparticles comprise an average effective diameter of ≦150 nm, particularly of ≦100 nm, for example of ≧40 nm to ≦80 nm, and/or a bimodal size distribution. The determination of the size, and the size distribution, respectively, via laser correlation spectroscopy is known in the art and described, for example, in T. Allen, Particle Size Measurements, Bd. L, Klüver Academic Publishers, 1999. In case silver nanoparticles are used, they may preferably be used, or introduced into the formulation, respectively, in the form of a silver nanoparticle sol (Ag sol).

The bimodal size distribution may especially be preferred with respect to electrically conductive structures such as patterns or coatings, having a low content of metal-based nanoparticles such as metal nanoparticles. It is believed that this effect is due to a filling of the occurring gusset volumes between larger particles by smaller particles. This results in large and continuous contact areas to be formed especially during thermal treatment of the ink formulation applied to the substrate. Consequently, the ink formulation according to the invention reaches, with low content of metal-based particles, the same electrical conductivity compared to formulations having a higher content of nanoparticles with monodispers size distributions of the nanoparticles and a comparable effective diameter, or even higher electrical conductivities compared to monodispers size distributions comprising a comparable amount of metal-based nanoparticles having the same effective diameter.

Due to the small effective diameter of the metal-based nanoparticles, structures having a very small width may additionally be achieved, which is especially preferred for defined patterns and/or for compact substrates. Apart from that, a structure may be achieved with a high contrast.

According to a further embodiment the fluorinated surfactant comprises poly-(oxetane) polymers comprising (—C₂F₅)-groups. These kinds of surfactants provide a plurality of advantageous properties. In detail, these surfactants have been found not to bioaccumulate. There is thus very low environmental impact because of which these surfactants are environmentally preferred even if being fluorosurfactants. Apart from that, the foam being generated may be reduced due to a reduced air entrapment because of which these surfactants lead to an improved wetting behavior and thus printing result. Furthermore, these surfactants are clear and uniform because of which they do not deteriorate the desired appearance of the ink formulation. Generally, flow, leveling, and surface appearance may be improved by using the surfactants like described above. The surfactants used according to this embodiment are purchasable under the names PolyFox PF-136A, PF-156A, and PF-151N from the company Omnova, for example.

According to a still further embodiment the non-fluorinated surfactant comprises a siloxane, in particular a polyalkyleneoxide modified heptamethyltrisiloxane. These kinds of surfactants are especially preferred wetting agents reducing the surface tension of the ink formulation according to this embodiment in an especially preferred manner. Particularly by using these kinds of non ionic surfactants, the wetting behavior and thus the distribution of the ink formulation, for example on a stamp and essentially independent from the stamp material, may be improved. For example, according to this embodiment, the non-fluorinated surfactant may be the one being purchasable under its name Silwet L77 from the company GE Silicones.

According to a still further embodiment the formulation contains at least
a) ≧31 to ≦42, in particular ≧36 to ≦37 parts by weight water,
b) ≧25 to ≦35, in particular ≧29 to ≦31 parts by weight alcohol,
c) ≧23.5 to ≦33.5, in particular ≧28 to ≦29 parts by weight metal-based nanoparticles,
d) ≧1 to ≦5 in particular ≧2.5 to ≦3.5 parts by weight non-fluorinated surfactant, and
e) ≧0.5 to ≦4.5, in particular ≧1.5 to ≦3 parts by weight fluorinated surfactant,
   wherein the above defined constituents a) to e) summarize to a concentration of ≦100 parts by weight in the formulation.

According to this embodiment, especially good results particularly with respect to microcontact printing may be achieved. In detail, the wetting behavior of hydrophobic substrates, such as poly-(dimethylsiloxane) is especially improved leading to exact and defined structures to be formed even in case the structures have very small dimensions.

It may be seen that the content of solvent and co solvent may be comparable. For example, the relation between water and alcohol may be 1/1.

Additionally, the amount of surfactants may be realized to a minor amount so that the composition essentially comprises metal-based nanoparticles, such as silver nanoparticles, water, and alcohol, such as methanol.

The present invention further relates to a method of generating structures, particularly being electrically conductive and/or reflective, on a substrate by microcontact printing, characterized by the steps of
A) Providing a stamp;
B) Applying a formulation according to the invention to at least a part of the surface of the stamp;
C) Transferring the formulation from the stamp to the substrate; and
D) Optionally treating the formulation transferred to the substrate with heat.

The method according to the invention thus defines a micro printing process using the ink formulation according to the invention.

According to step A), a stamp is provided. The stamp may be formed from a suitable material, such as a hydrophobic material. However, the advantages such as the wetting behavior being obtained by using the formulation according to the invention may generally as well be achieved by using hydrophilic stamps. Particularly, however, the stamp may at least partly be formed from poly-(dimethylsiloxane). Additionally, the stamp may be structured and may thus comprise the structure which is to be printed on the substrate. In other words, the stamp may at least partly be structured particularly on that surface being used for printing purposes. Consequently, the exact form of the stamp or at least of one surface of the latter is dependent on the desired printing image. As a result, the stamp may comprise one large flat surface in case a large coating is to be applied to the substrate. Furthermore, the stamp may comprise a defined pattern in case such a pattern is to be applied to the surface of the substrate. For example, the pattern may correspond to a pattern of conducting lines being required for electrical compounds, and may thus comprise relief patterns. This may be realized, for example, by respective protruding and recessed portions on the surface of the stamp, like it is known from microcontact printing as such.

According to step B), a formulation according to the invention is applied onto at least a part of the surface of the stamp. In detail, the ink formulation is applied to the printing surface of the stamp and thus to that surface being used for printing purposes. Consequently, the formulation is applied to the surface comprising the desired structure or pattern, respectively by any known and appropriate technique thereby wetting the latter. For example, the ink formulation may be applied to the printing surface of the stamp by immersing the latter at least partly into the formulation or by spraying the formulation onto the stamp, for example. After having wetted the surface of the stamp with the formulation, the excess formulation may be removed, or wicked, respectively, from the stamp, for example by using a wire bar.

According to step C), the formulation is transferred from the stamp to the substrate in order to generate the structure on the substrate. In other words, the surface of the stamp being treated with the formulation, i.e. the printing surface, is brought into physical contact with the desired surface of the substrate to be printed. In case the printing surface of the stamp comprises protruding and recessed portions, for example, the ink may wet both portions during step B). However, only the formulation being present on the protruding portions will be transferred to the substrate so that the desired structure is applied to the surface of the substrate. Especially in case the stamp is elastic this step may be improved.

The substrate to which the formulation is transferred may, for example, be such a substrate being electrically insulating or having only a limited electrical conductivity, for example formed from a flexible material. As an example, the substrate may be formed from glass or plastics, such as a glass plate or a plastic foil, or it may be a polymer, such as a polymer film, or a silicium wafer, for example.

Additionally, according to step D) a step of treating the formulation transferred to the substrate with heat may follow. During this step, the formulation may be sintered in order to achieve a coating having especially improved properties, i.e. particularly with respect to being electrically conductive and/or being optically reflective. Additionally, the solvents and/or liquids being present in the formulation may be removed. Step D) may be performed under mild conditions. For example, temperatures of more than 40° C. may be used. However, preferred temperatures may lie in the range of ≧150° C. to ≦500° C., particularly in the range of ≧300° C. to ≦400° C., for example at 350° C. The temperature range may preferably be chosen in dependence of the substrate and may thus be maintained below the melting temperature or softening point of the substrate. It is thus possible to achieve electrically conductive and/or optically reflective structures on temperature sensible substrates. Step D) may for example be performed by laser sintering, microwave sintering, or by low temperature sintering. However, step D) is in some cases not strictly necessary and is thus not mandatory, but optional.

With respect to the duration of step D), the temperature treatment may be performed, for example, for a period of ≧1 minute to ≦24 hours. Preferred durations lie in the range of ≧5 minutes to ≦120 minutes, for example.

With respect to further advantages of the method according to the invention it is referred to the above remarks with respect to the inventive formulation.

The present invention further relates to a substrate comprising a structure being particularly electrically conductive and/or reflective and being obtainable by a formulation according to the invention, particularly by microcontact printing.

Electrically conductive structures according to the present invention are particularly patterns and/or coatings having an electrical conductivity being suitable for conducting paths. Accordingly, electrically conductive structures are particularly and exemplarily those having a conductivity of more than 10 μS/cm.

Due to a usage of the formulation according to the invention especially in combination with microcontact printing in order to obtain the substrate according to the invention, the electrically conductive and/or optically reflective structures may have any desired shape and geometry. The structures may comprise lines, or patterns, respectively, having a width in the range of less than 100 μm, for example up to 20 μm.

The particularly electrically conductive and/or optically reflective structures on the substrate may be flexible so that by bending the substrate, the conductivity, for example, is maintained. Additionally, the substrate may be transparent.

The substrate may preferably at least partly be formed from a material being selected from the group consisting of glass, polyimide (PI), polycarbonate (PC), polyethylenterephtalate (PET). These materials provide suitable surface behaviors with respect to printing and may easily be functionalized. However, the list of substrate materials is not limited to the above named examples.

The combination of mechanical properties such as stability or flexibility, optical properties such as transparency or reflectivity and/or the electrical properties such as electrical conductivity especially with respect to transparent plastics lead to a broad range of applications of a substrate having a structure like defined above. Especially preferred applications comprise in a non limiting manner windows such as for vehicles, devices or buildings being coupled with electrical applications (heating, discharging electrical charges, shielding of electromagnetic waves), or solar cells especially with respect to their sides facing the sun. Thereby, the degree of freedom with respect to design is nearly unlimited furthermore increasing the range of applications.

With respect to further advantages of the substrate according to the invention it is referred to the above remarks with respect to the inventive formulation as well as the inventive method.

The present invention is subsequently described with regard to embodiments and with respect to the figures, without being limited to the following description.

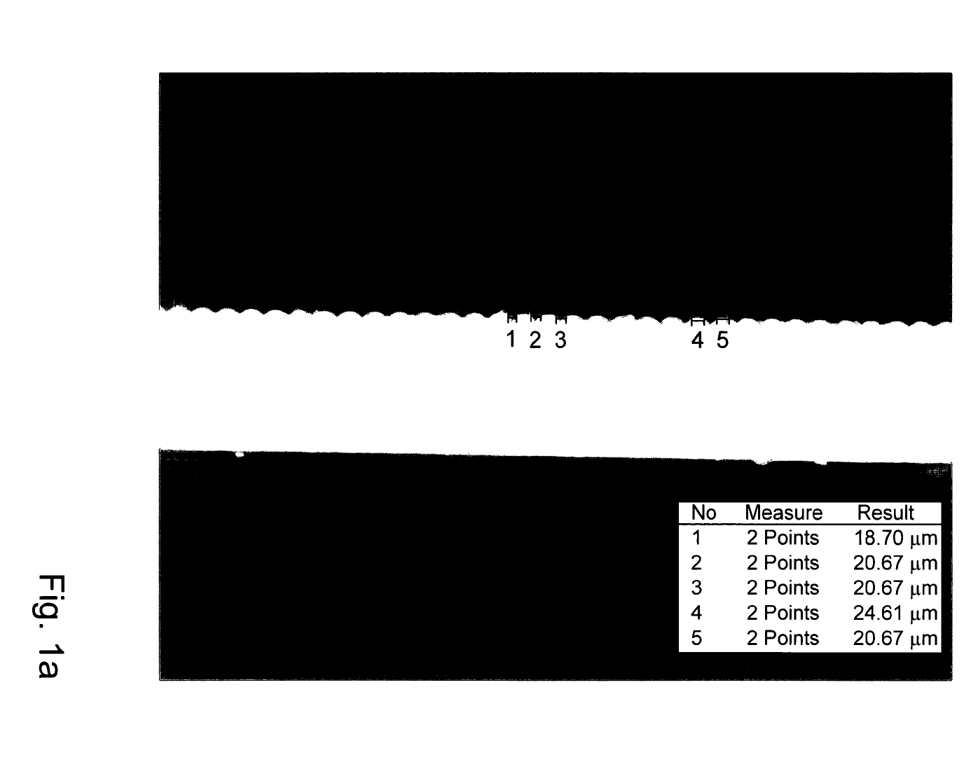

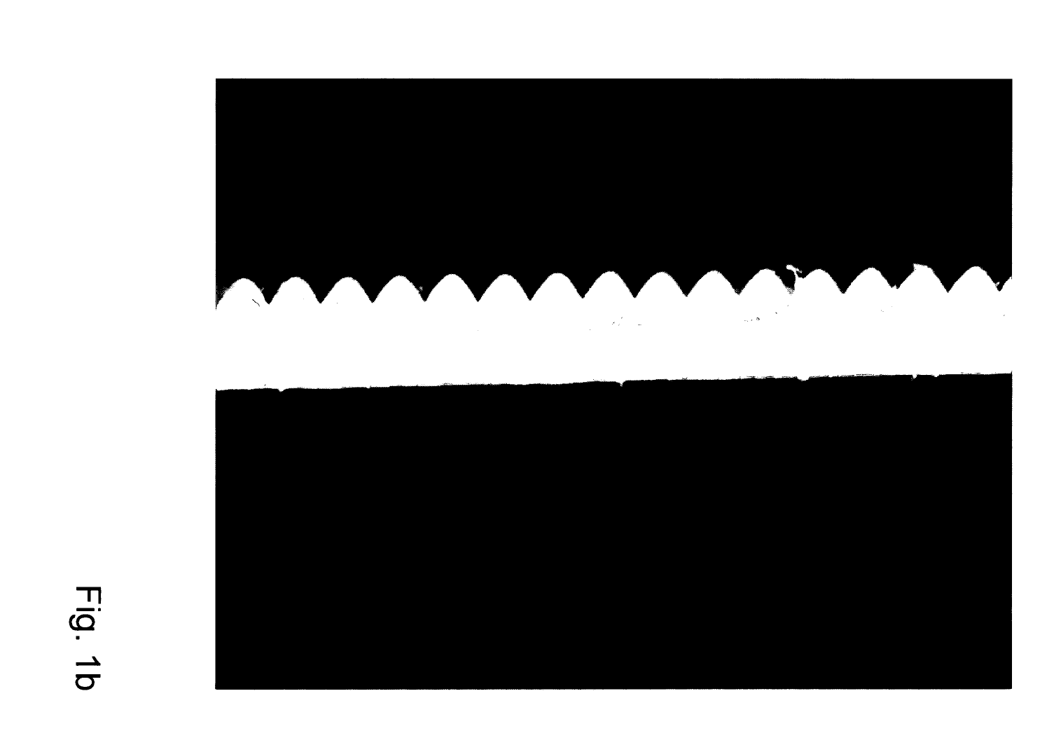

FIG. 1a shows a microscope image of a polycarbonate foil being used for obtaining a stamp for performing the method according to the invention;

FIG. 1b shows a microscope image of a further polycarbonate foil being used for obtaining a stamp for performing the method according to the invention;

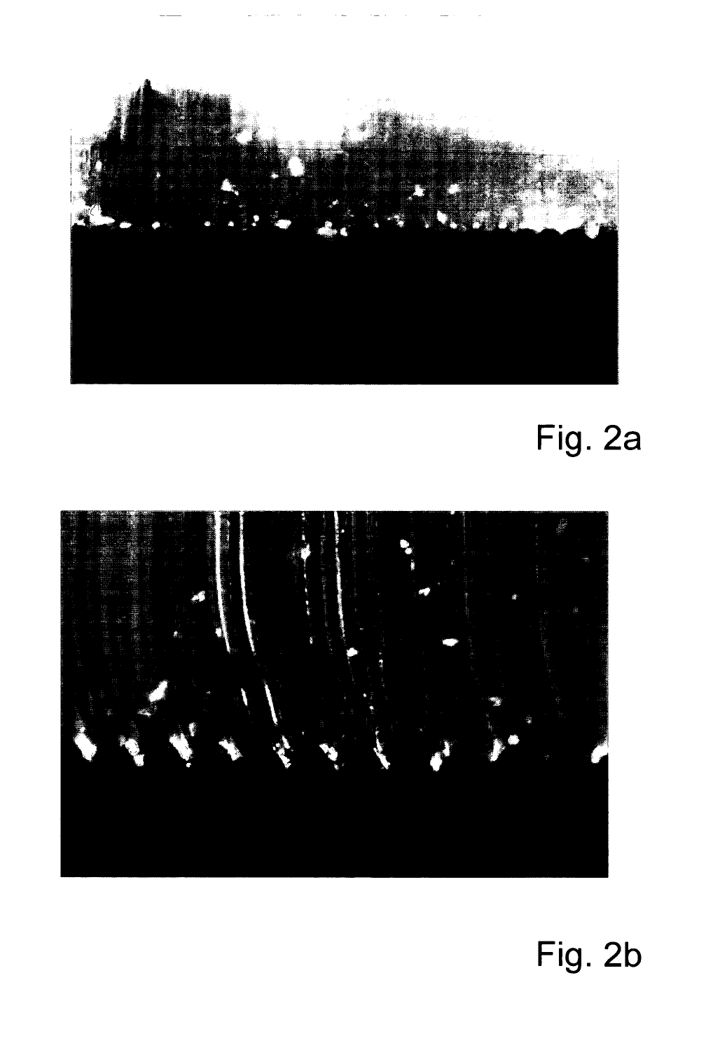

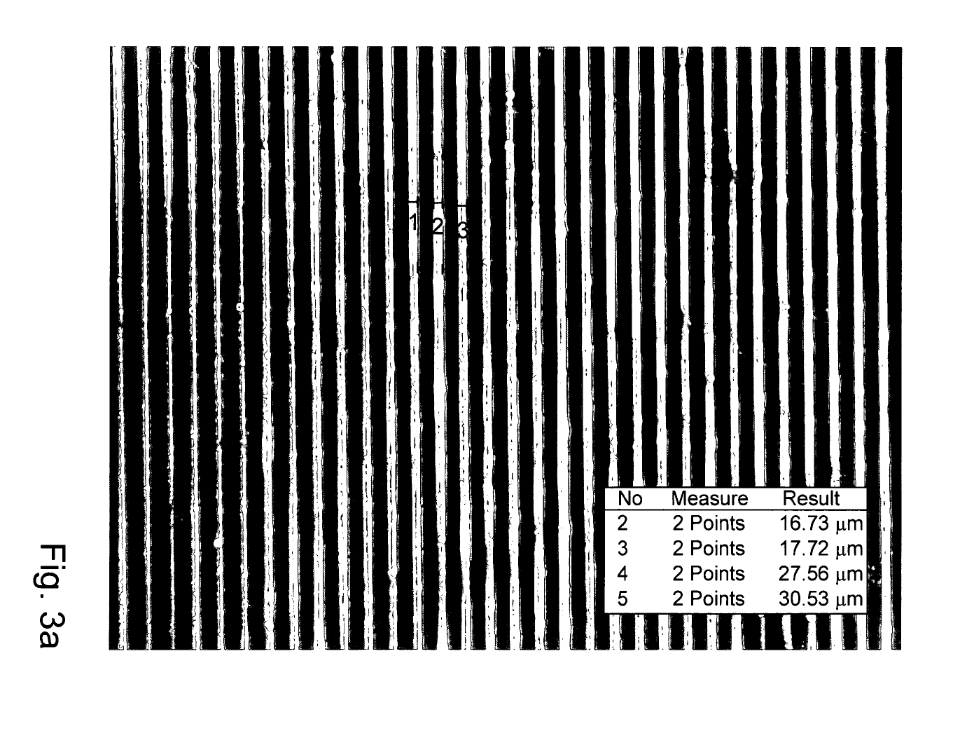

FIG. 2a shows a microscope image of a part of a stamp being obtained from the foil according to FIG. 1a;

FIG. 2b shows a microscope image of a part of a stamp being obtained from the foil according to FIG. 1b;

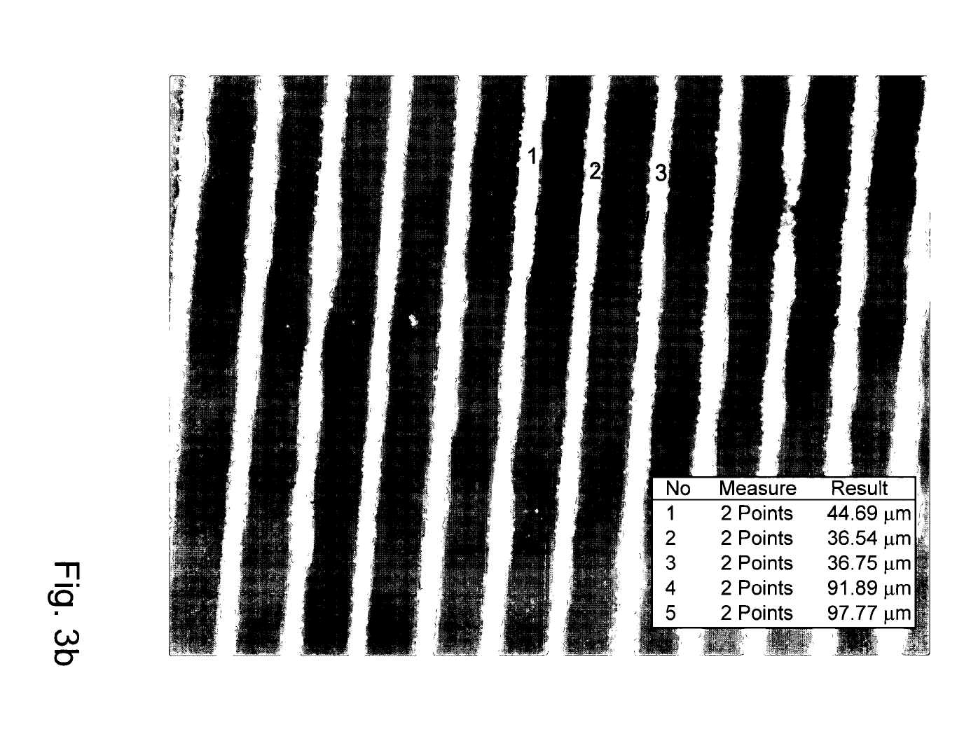

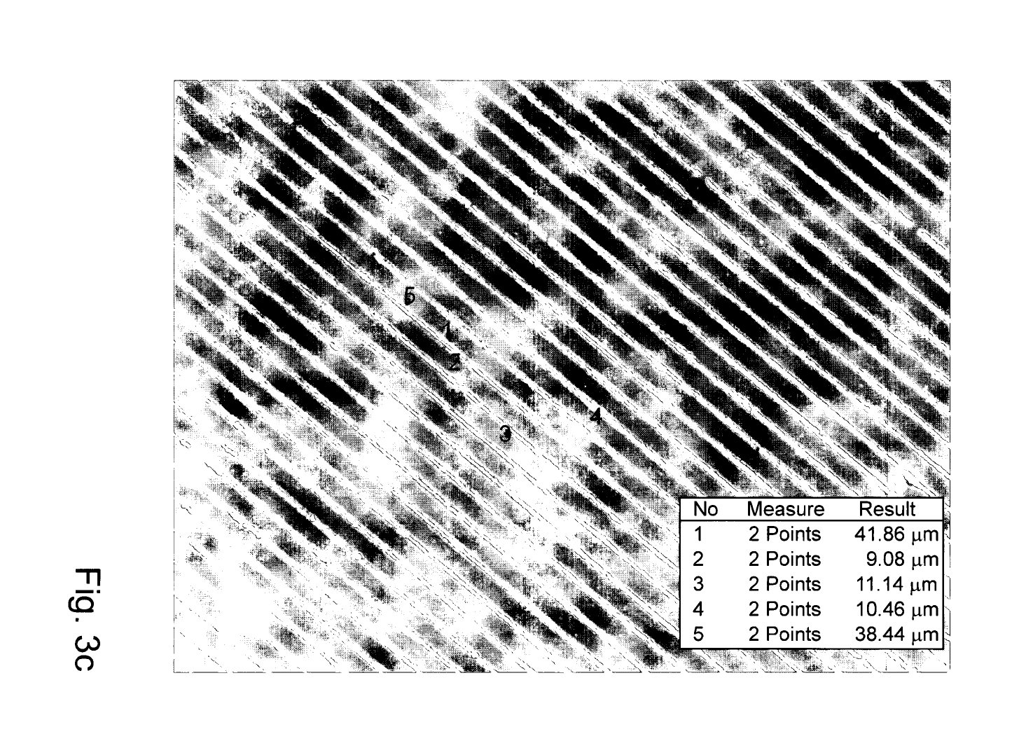

FIG. 3a shows a microscope image of an embodiment of a printed structure generated by the method according to the invention;

FIG. 3b shows a microscope image of a further embodiment of a printed structure generated by the method according to the invention;

FIG. 3c shows a microscope image of a further embodiment of a printed structure generated by the method according to the invention; and

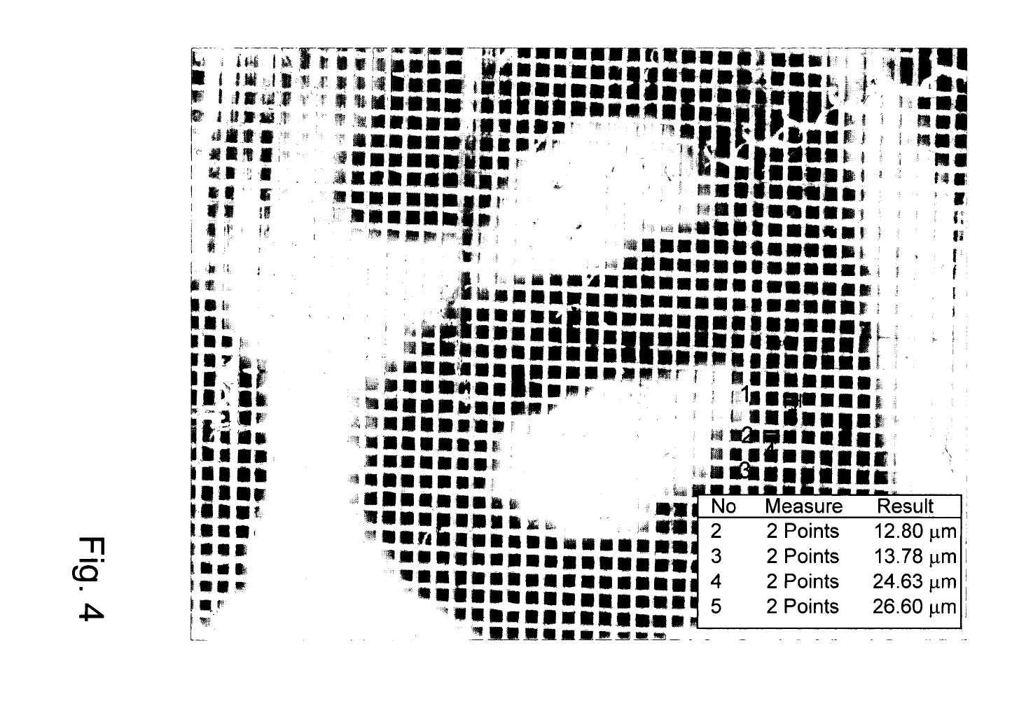

FIG. 4 shows a microscope image of a further embodiment of a printed structure generated by the method according to the invention.

### EXAMPLE

The following ink formulation according to the present invention was used (table 1), wherein L77 represents the non-fluorinated surfactant “Silwet L77”, purchasable under its name by the company GE silicones, “Polyfox 156” represents the fluorinated surfactant, purchasable by its name by the company Omnova, methanol represents conventional methanol, Ag sol represents silver nanoparticles stabilized by Disperbyk 190, purchasable by BYK-Chemie, and DI water represents deionized water.

TABLE 1

| | | Weight | % Conc. Of Raw | % Conc. In |
|---|---|---|---|---|
| Serial No. | Raw materials | (g) | Material | Ink |
| 1 | L77 | 1.5 | 100.00 | 2.99 |
| 2 | Polyfox 156 | 11.20 | 10.00 | 2.24 |
| 3 | Methanol | 14.95 | 100.00 | 29.90 |
| 4 | Ag Sol | 22.40 | 63.63 | 28.5 |
| 5 | DI Water | | | 36.37 |

The above defined formulation was used for microcontact printing. Consequently, with regard to the method according to the present invention, firstly, a stamp has to be provided. As stamp material, poly-(dimethylsiloxane) was chosen.

The respective stamp was prepared using Sylgard 184, purchasable by the company Dow Corning. This 2-part silicone elastomer can be cured at room temperature, as well as up to temperatures of 150° C. The silicone elastomer base and the curing agent of the Sylgard 184 mixture were mixed in the ratio 10:1. The mixture was then transferred into a Thinky biaxial mixer for 90 sec at 2000 rpm and subsequently for 60 sec at 2200 rpm for defoaming. The slurry obtained was added into a beaker containing structured polycarbonate foils from Dr. Pudliner.

Digital images showing the structures of different polycarbonate foils used for generating the patterned stamps are shown in FIGS. 1a and 1b. From FIG. 1a it can be seen that the foil comprises protuding regions (4 and 5) and recessed regions (1 to 3). The protruding regions all have thicknesses in the range of ≧20 μm to ≦25 μm, whereas the recessed regions have dimensions in the range of ≧18 μm to ≦21 μm. The foil according to FIG. 1b is comparable to the foil according to 1a even though the recesses are deeper with regard to the whole thickness of the foil. The structure being present on the foils corresponds to the structure of the stamp and thus of the structure to be printed onto the substrate.

After having added the slurry into a beaker containing structured polycarbonate foils like described above, the beaker was then kept in a vented oven and the poly-(dimethylsiloxane) slurry was cured at 125° C. for 1 h. The beaker was then taken out allowed to cool down to room temperature and was broken to retrieve the poly-(dimethylsiloxane) stamp to be used as stamp in microcontact printing.

The stamps being obtained are shown in FIG. 2, wherein the stamp shown in FIG. 2a is obtained from the foil according to FIG. 1a whereas the stamp being shown in FIG. 2b is obtained from the foil being shown in FIG. 1b.

Having formed the stamp, the latter may be used for microcontact printing using the formulation shown in table 1. The microcontact printing process was performed as discussed below. The poly-(dimethylsiloxane) stamp was wetted with the silver nanoparticle ink of the formulation according to the invention. The excess ink was then wicked by using a 10 μm wire bar. This step may be especially preferred as it helps removing the excess ink from the stamp and thereby allows a good transfer of the pattern from the stamp to the substrate of choice. It is also possible to increase or even eliminate the aforementioned wicking step by increasing the viscosity of the ink system, so that only the “hills” and thus the protruding portions of the stamp are wettet, or coated, respectively, and not the “valleys”, or the recessed portions.

After having wetted the stamp or its structure, respectively, with the formulation, the structure is brought into physical contact with the substrate, in this case being a glass substrate, in order to generate an electrically conductive and/or optically reflective structure onto the surface of the substrate. The structure according to this example comprised a plurality of thin lines. In order to improve or to generate the electrical conductivity, the silver lines obtained could be sintered in an oven under preferred conditions, such as a temperature range of ≧150° C. to ≦500° C. for a time range of ≧1 minute to ≦2 hours to make them especially electrically conductive and to remove the solvent, or liquids, respectively. Digital images of the lines thus printed could be seen by microscope images below in FIGS. 3a, 3b and 3c. Different line thicknesses could be obtained by choosing poly-(dimethylsiloxane) stamps with different dimensions or by adjusting the pressure during the printing process in an appropriate manner.

In detail, FIG. 3a shows a pattern of silver lines comprising a line width of approximately 17 μm and spacings there between of approximately 30 μm. FIG. 3b shows a pattern of silver lines comprising a line width of approximately 40 μm and spacings there between of approximately 95 μm. FIG. 3c shows a pattern of silver lines comprising a line width of approximately 10 μm and spacings there between of approximately 40 μm.

It was also possible to print semi-transparent grid patterns by performing two consecutive printings, with orientations perpendicular to each other. For example, after the first print of the silver nanoparticle ink the glass substrate with the pattern was sintered at 350° C. for 10 min. After which, the substrate was cooled and a second print with an orientation perpendicular to the first print was made. The substrate with the print was also sintered at 350° C. for another 10 min. This process resulted in a semi-transparent conductive grid pattern. The microscope images are given in FIG. 4 showing microscope images of the printed grid lines. The grid lines comprise a 12 μm grid with a 25 μm spacing. The sheet resistance was measured to be 0.5 Ω/sq. The lines printed show a thickness of about 250 nm.

As shown above, the ink formulation according to the invention allows printing very thin lines, or patterns, respectively. Consequently, the pattern being formed by the stamp is appropriately transferred to the substrate. This shows a very well wetting behavior and furthermore very well printing results.

Additionally, the improved wetting behavior of the formulation according to the invention could be seen by applying it to a non structured and thus plane poly-(dimethylsiloxane) surface. In detail, when having applied the formulation defined in table 1 onto such a poly-(dimethylsiloxane) surface, a contact angle of 33.3° (with a standard deviation of 0.5°) on the surface was obtained. This shows that even hydrophobic surfaces may be applied with the ink formulation according to the invention very well leading to an improved wetting behavior.

While the invention has been illustrated and described in detail in the drawings and foregoing description, such illustration and description are to be considered illustrative or exemplary and not restrictive, the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An aqueous formulation for generating electrically conductive and/or reflective structures by microcontact printing, comprising
a) ≧15 to ≦55 parts by weight water,
b) ≧10 to ≦50 parts by weight alcohol,
c) ≧15 to ≦45 parts by weight metal-based nanoparticles,
d) ≧0.5 to ≦10 parts by weight non-fluorinated surfactant, and
e) ≧0.5 to ≦10 parts by weight fluorinated surfactant,
wherein the above defined constituents a) to e) add up to a concentration of ≦100 parts by weight in the formulation.

2. A formulation according to claim 1, characterized in that the metal-based nanoparticles comprise silver nanoparticles.

3. A formulation according to claim 1, characterized in that the alcohol is ethanol, isopropanol, methanol, or a mixture thereof.

4. A formulation according to claim 1, characterized in that the metal-based nanoparticles comprise an average effective diameter of ≦150 nm or a bimodal size distribution.

5. A formulation according to claim 1, characterized in that the fluorinated surfactant comprises poly-(oxetane) polymers comprising (—C₂F₅)-groups.

6. A formulation according to claim 1, characterized in that the non-fluorinated surfactant comprises a siloxane.

7. A formulation according to any claim 1, characterized in that the formulation further comprises at least one additive selected from the group consisting of surfactants, pigments, defoamers, light protecting agents, lighteners, whiteners, corrosion inhibitors, antioxidants, algicides, plasticizers, softeners, and thickeners.

8. A formulation according to claim 1, characterized in that the formulation contains at least
a) ≧31 to ≦42 parts by weight water,
b) ≧25 to ≦35 parts by weight alcohol,
c) ≧23.5 to ≦33.5 parts by weight metal-based nanoparticles,
d) ≧1 to ≦5 parts by weight non-fluorinated surfactant, and
e) ≧0.5 to ≦4.5 parts by weight fluorinated surfactant,
wherein the above defined constituents a) to e) add up to a concentration of ≦100 parts by weight in the formulation.

9. A method of generating structures on a substrate by microcontact printing, characterized by the steps of
A) Providing a stamp;
B) Applying a formulation according to claim 1 to at least a part of the surface of the stamp;
C) Transferring the formulation from the stamp to the substrate; and
D) Optionally treating the formulation transferred to the substrate with heat.

10. A method according to claim 9, characterized in that a stamp is used which is at least partly formed from a hydrophobic material.

11. A method according to claim 9, characterized in that a stamp is used which is at least partly structured.

12. A substrate comprising a structure being particularly electrically conductive and/or reflective and being obtainable by a formulation according to claim 1 by microcontact printing.

13. A formulation according to claim 1, characterized in that the metal-based nanoparticles comprise an average effective diameter of ≦100 nm or a bimodal size distribution.

14. A formulation according to claim 8, characterized in that the formulation contains at least
a) ≧36 to ≦37 parts by weight water,
b) ≧29 to ≦31 parts by weight alcohol,
c) ≧28 to ≦29 parts by weight metal-based nanoparticles,
d) ≧2.5 to ≦3.5 parts by weight non-fluorinated surfactant, and
e) ≧1.5 to ≦3 parts by weight fluorinated surfactant,
wherein the above defined constituents a) to e) add up to a concentration of ≦100 parts by weight in the formulation.
